(19) United States
(12) Patent Application Publication
(10) Pub. No.: US 2023/0298219 A1
(43) Pub. Date: Sep. 21, 2023

(54) A METHOD AND AN APPARATUS FOR UPDATING A DEEP NEURAL NETWORK-BASED IMAGE OR VIDEO DECODER

(71) Applicant: InterDigital VC Holdings France, SAS, Cesson-Sevigne (FR)

(72) Inventors: Franck Galpin, Thorigne-Fouillard (FR); Fabien Racape, San Francisco, CA (US); Jean Begaint, Menlo Park, CA (US); Fabrice LeLeannec, Betton (FR)

(21) Appl. No.: 18/013,645

(22) PCT Filed: Jul. 12, 2021
(86) PCT No.: PCT/EP2021/069291

§ 371 Date: Dec. 29, 2022

(30) Foreign Application Priority Data
Jul. 21, 2020 (EP) 20305838.3

(51) Int. Cl. G06T 9/00

(52) U.S. Cl. CPC G06T 9/002

(57) ABSTRACT

A method and an apparatus for decoding at least one part of at least one image is disclosed. The method comprises decoding at least one update parameter and modifying a deep neural network-based decoder based on said decoded update parameter. The method further comprises decoding at least one part of at least one image using at least said modified decoder.

### TECHNICAL FIELD

The present embodiments generally relate to a method and an apparatus for encoding and decoding images and video, and more particularly, to a method or an apparatus for efficiently providing video compression and/or decompression based on end-to-end deep learning or deep neural network.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method of updating a Deep Neural Network-based decoder is provided comprising decoding at least one update parameter and modifying the deep neural network-based decoder based on said decoded update parameter.

According to another embodiment, an apparatus for updating a Deep Neural Network-based decoder is provided, comprising one or more processors, wherein said one or more processors are configured to decode at least one update parameter, and modify the deep neural network-based decoder based on said decoded update parameter.

According to another embodiment, a method for obtaining an update parameter for updating a Deep Neural Network-based decoder is provided, comprising: obtaining at least one update parameter for modifying a deep-neural-network-based decoder defined from a training of a deep neural network-based auto-encoder using a first training configuration, said at least one update parameter being obtained as a function of a training of said deep neural network-based auto-encoder using a second training configuration, and encoding said at least one update parameter.

According to another embodiment, an apparatus for obtaining an update parameter for updating a Deep Neural Network-based decoder is provided, comprising one or more processors, wherein said one or more processors are configured to obtain at least one update parameter for modifying a deep-neural-network-based decoder defined from a training of a deep neural network-based auto-encoder using a first training configuration, said at least one update parameter being obtained as a function of a training of said deep neural network-based auto-encoder using a second training configuration, and encode said at least one update parameter.

One or more embodiments also provide a computer program comprising instructions which when executed by one or more processors cause the one or more processors to perform the methods according to any of the embodiments described below. One or more of the present embodiments also provide a computer readable storage medium having stored thereon instructions for performing the methods according to any of the embodiments described below. One or more embodiments also provide a computer readable storage medium having stored thereon a bitstream generated according to the methods described herein. One or more embodiments also provide a method and apparatus for transmitting or receiving the bitstream generated according to the methods described herein.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4A illustrates a diagram of an embodiment of an auto-encoder.

FIG. 4B illustrates a diagram of an embodiment of a Deep Neural network-based encoder.

FIG. 4C illustrates a diagram of an embodiment of a Deep Neural network-based decoder.

FIG. 5A illustrates a method for obtaining at least one update parameter for a DNN-based decoder, according to an embodiment.

FIG. 5B illustrates an embodiment for obtaining the update parameter of the DNN-based decoder.

FIG. 5C illustrates a method for encoding at least one image or a part of at least one image according to an embodiment.

FIG. 6A illustrates a method for updating a DNN-based decoder, according to an embodiment.

FIG. 6B illustrates a method for decoding at least one part of at least one image, according to an embodiment.

FIG. 7 illustrates an exemplary diagram of an embodiment of a DNN-based encoder and a DNN-based decoder.

FIG. 8A illustrates a diagram of an embodiment for modifying a decoder part of an auto-encoder.

FIG. 8B illustrates a diagram of another embodiment for modifying a decoder part of an auto-encoder.

FIG. 8C illustrates a diagram of another embodiment for modifying a decoder part of an auto-encoder.

FIG. 8D illustrates a diagram of another embodiment for modifying a decoder part of an auto-encoder.

FIG. 9 illustrates a diagram of an embodiment of an auto-encoder with multiple decoder outputs.

FIG. 10 illustrates a diagram of an embodiment of an auto-encoder for layer update training.

FIG. 11 illustrates a diagram of another embodiment of an auto-encoder for layer update training.

FIG. 12 shows two remote devices communicating over a communication network in accordance with an example of present principles.

FIG. 13 shows the syntax of a signal in accordance with an example of present principles.

FIG. 14 illustrates a diagram of an embodiment of an apparatus for transmitting a signal according to an embodiment.

FIG. 15 illustrates an exemplary method for transmitting a signal according to an embodiment.

### DETAILED DESCRIPTION

Some image and video coding schemes employ Deep Neural Networks (DNN) in some or all parts of the coding-decoding schemes.

DNNs are trained using several types of losses: “objective metric” and “subjective” metric. Loss based on an “objective” metric may be typically Mean Squared Error (MSE) or based on structural similarity (SSIM) for instance. The results may not be perceptually as good as the “subjective metric”, but the fidelity to the original signal (image) is higher. Loss based on “subjective” (or subjective by proxy) may be typically using Generative Adversarial Networks (GANs) during the training stage or advanced visual metric via a proxy Neural Network (NN). Depending on the loss used for training, the resulting parameters of the DNN model may be different.

The DNN models are trained using several types of training sets. A same network can be first trained on a generic training set, allowing a satisfactory performance on a large range of content types. The DNN model can also be fine-tuned using a specific training set for a specific usage, improving the performance on a domain specific content. These different trainings will result in different trained models.

Therefore, there is a need for a Deep Neural network (DNN) for compression suitable to run in both objective and perceptual/subjective quality. While objective metrics give visually poorer results, they offer several advantages:
fidelity to the original signal: depending on the application, such property could be crucial (e.g. scientific images, artistic images, video surveillance etc.)
temporal stability in case of video compression: an image compressed using an objective metric is usually more suitable to be used as a reference to encode another frame of the video.
conceptually, subjective metrics are very hard to define accurately. For example, semantics-based metrics could be used in the loss, but reconstructed images will then be very different from the original signal.

On the other hand, subjective metrics allow for more pleasing results perceptually, especially at low bitrates.

In a same way, a generic training set ensures that compression performance is consistent on a wide range of content, but a specific training set could reach better performances for specific applications. Additionally, auto-encoder solutions may be trained at given rate-points, i.e. the weights of the models are optimized for a specific range of bitrates of the transmitted bitstream.

Current methods using end-to-end compression network usually train a unique network, either for an objective metric (typically MSE/PSNR for Peak Signal to Noise Ratio), or using a perceptual metric, typically using GANs or advanced perceptual metric loss. In traditional codecs, quantization matrices and encoding methods are used to adapt the codec to more perceptually oriented quality or specific content. Typically, carefully chosen non-flat matrices, even if degrading the PSNR, allow to increase the visual quality of reconstructed frames.

According to an embodiment, a network using objective metrics and/or generic training set is trained. Network updates are used to turn the decoder network into a perceptual based decompressor or domain specific decompressor. The updates may be small and fixed, so that an application can optimize the decoding process knowing the decoder architecture and most of the layers are fixed (i.e. weights are known). In practice, a hardware version of the decoder could be implemented and used together with a thin software process for updating the decoder.

According to an embodiment, an auto-encoder (AE) is trained using a first training configuration, for instance using an objective metric such as MSE for “signal” based fidelity of the compression, using a generic training set. Layers are added and/or removed to/from the decoder and/or adapted to change the decoder reconstruction. Both encoder and some layers of the decoder could be updated. The auto-encoder is then re-trained or fine-tuned using another training configuration, for instance using a subjective metric or a specific training set, or for specific bitrates.

A training configuration is defined by a metric used in the loss function, and a training set of samples or batch which are input to the auto-encoder so that the auto-encoder learns its parameters. The other training configuration could differ from the first training configuration from the metric which could be an objective or perceptual/subjective quality metric and/or the training set which could be a generic training set or a training set with specific contents. The training configurations could also differ in the Lagrange parameters for updating or refining in a light way a DNN to adapt to different bitrate levels.

According to another embodiment, multiple decoder outputs are provided, keeping an objective output only in the loop, i.e. in case of temporal prediction. The objective output will be used in the coding loop, while the subjective output could be used for display.

According to another embodiment, syntax elements are sent to the decoder along with the bitstream or as side information, for updating the decoder.

In the following, the description provides exemplary embodiments related to the adaptation of the auto-encoder to perceptual metrics. However, the scope of the disclosure is not limited to perceptual optimization. In particular, videos could also be used for machine tasks, e.g. object tracking, segmentation etc. in different contexts such as self-driving vehicles, video surveillance etc. The model adaptations described below are also applicable in these contexts where the perceptual metric could be replaced by accuracy metrics of a machine task algorithm which takes as input the decompressed video.

The model adaptations described below are also applicable to specialize the coding/decoding framework to some specific type of video content. In this context, the training of one or more modified network layers and the fine tuning of the network may be specifically focused on the considered specific video content type. As an example, video gaming content may be a considered specific content type.

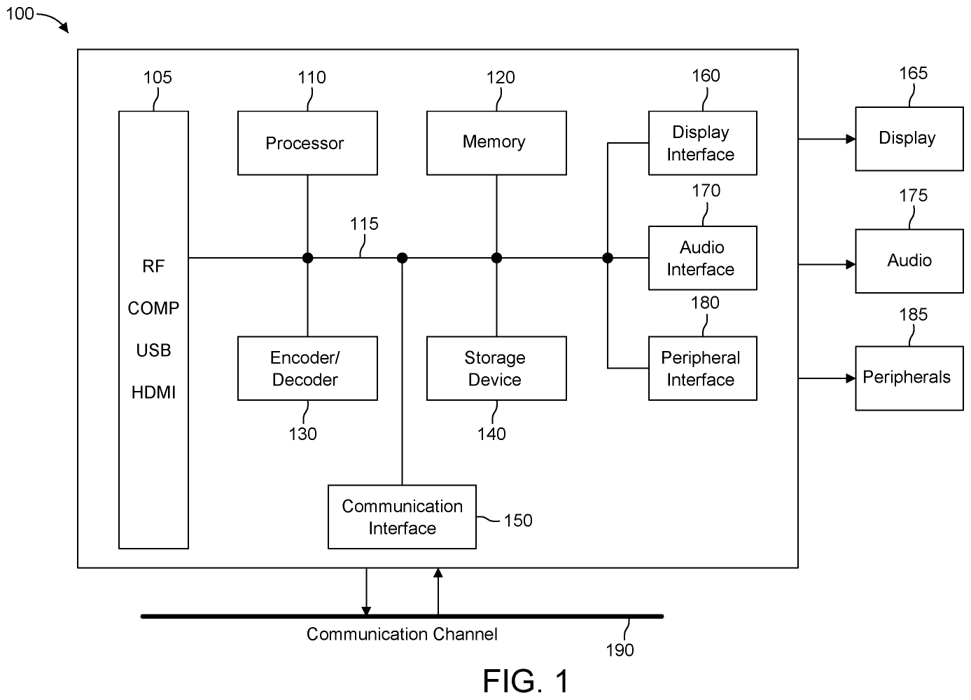

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

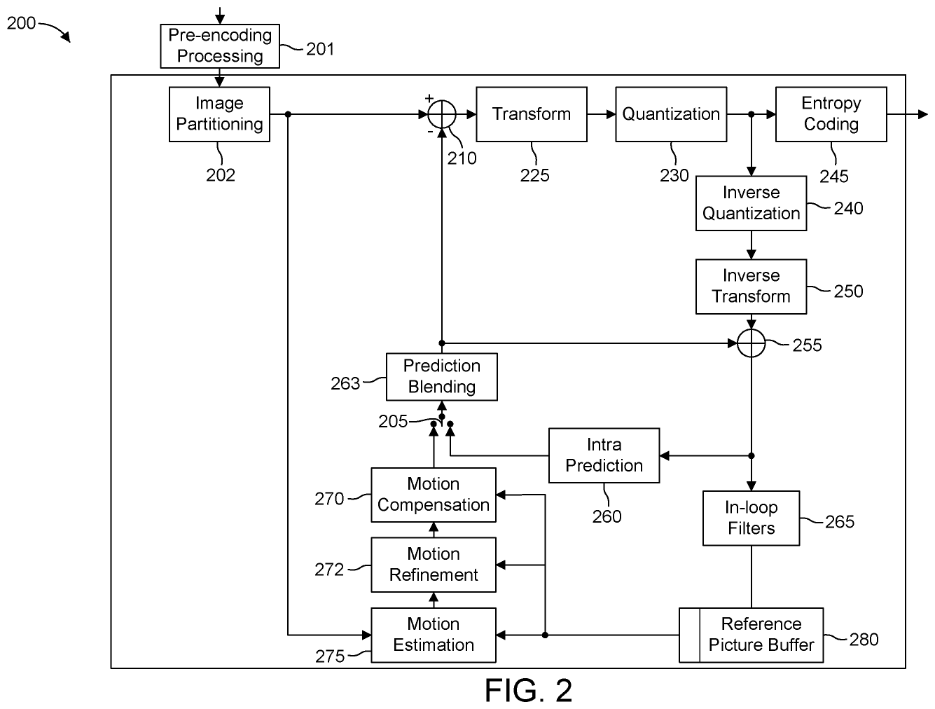

FIG. 2 illustrates an example video encoder 200, such as a High Efficiency Video Coding (HEVC) encoder. FIG. 2 may also illustrate an encoder in which improvements are made to the HEVC standard or an encoder employing technologies similar to HEVC, such as a VVC (Versatile Video Coding) encoder under development by JVET (Joint Video Exploration Team).

In the present application, the terms “reconstructed” and “decoded” may be used interchangeably, the terms “encoded” or “coded” may be used interchangeably, the terms “pixel” or “sample” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods.

Prediction residuals are calculated, for example, by subtracting (210) the predicted block from the original image block. The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

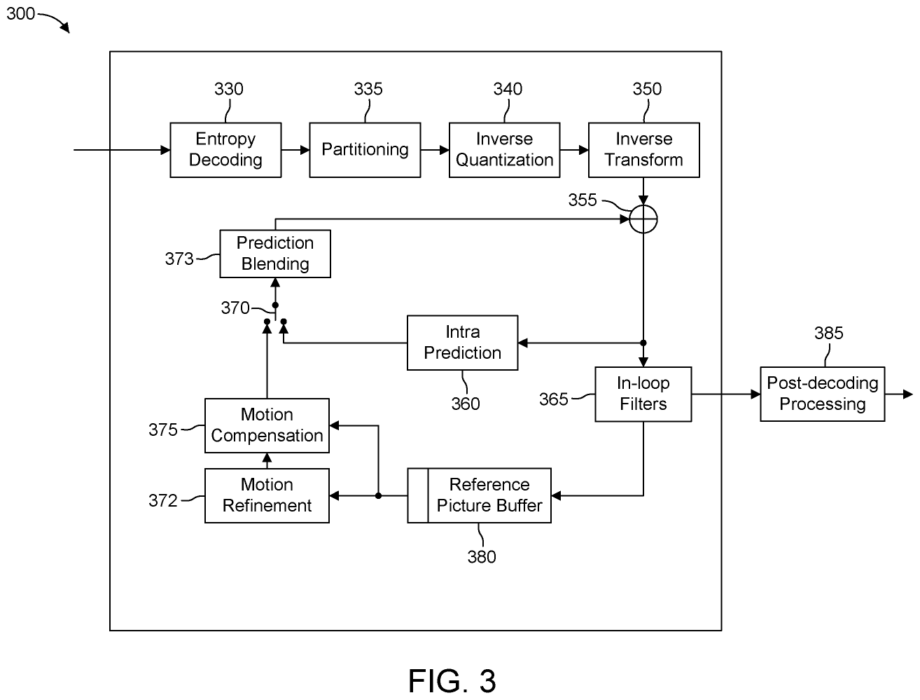

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

According to an embodiment, all or parts of the video encoder and decoder described in reference to FIG. 2 and FIG. 3 may be implemented using Deep Neural Networks (DNN).

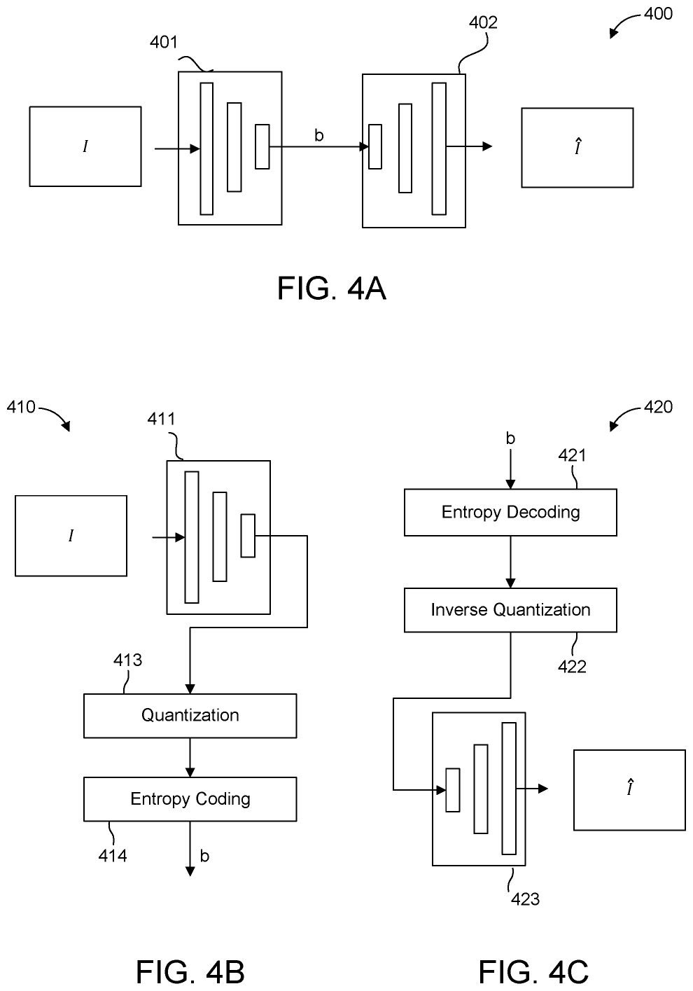

FIG. 4A illustrates a diagram of an embodiment of an auto-encoder based on end-to-end compression using DNN 400. The auto-encoder 400 comprises an encoder part 401 (the set of operations to the left of bitstream b) configured for encoding an input I and producing a bitstream b, and a decoder part 402 configured for reconstructing an output Î from the bitstream b.

The input I of the encoder part 401 of the network may consist of
an image or frame of a video,
a part of an image,
a tensor representing a group of images,
a tensor representing a cropped part of a group of images.

The input I may have one or multiple components, e.g monochrome, RGB or YUV components.

The encoder network 401 is usually composed of a set of convolutional layers with stride, allowing to reduce the spatial resolution of the input while increasing the depth, i.e. the number of channels of the input. Squeeze operations may also be used instead of strided convolutional layers (space-to-depth via reshaping and permutations). In the exemplary embodiment illustrated on FIG. 4A, three layers are shown but less or more layers could be used.

The output of the encoder, which consists of a tensor sometimes referred to as a latent in the following, is then quantized, and entropy coded to produce a bitstream b. At training, a so-called “spatial-bottleneck” which reduces the number of values in the latent or an “entropy-bottleneck” to simulate the entropy coding module are used to allow compression of the original data. “b” is called the bitstream, i.e. the set of coded syntax elements and payloads of bins representing the quantized symbols, transmitted to the decoder.

The decoder part 402, after entropy decoding the quantized symbol from the bitstream b, inputs the values to a set of layers usually composed of (de) convolutional layers (or depth-to-space squeeze operations). The output of the decoder 402 is the reconstructed image Î or a group of images.

Note that some more sophisticated layouts exist, for example adding an “hyper-autoencoder” (hyper-prior) to the network in order to jointly learn the latent distribution properties of the encoder output. More details on such auto-encoder can be found in “Joint Autoregressive and hierarchical priors for learned image compression”, D. Minnen, J. Ballé, G. Toderici, NIPS 2018′.

FIG. 4B illustrates a diagram of an embodiment of a Deep Neural network-based image or video encoder 410. According to an embodiment, the encoder 410 is part of a block-based encoder described above with FIG. 2. According to another embodiment, the encoder 410 is part of an auto-encoder, such as the auto-encoder described with FIG. 4A. The encoder 410 comprises a Deep Neural Network composed of a set of convolutional layers with stride, which produces a latent. The latent is then quantized (413) and entropy coded (414) to produce a bitstream b.

FIG. 4C illustrates a diagram of an embodiment of a Deep Neural network-based image or video decoder 420. According to an embodiment, the decoder 420 may be part of a block-based decoder such as described above with FIG. 3. According to another embodiment, the decoder 420 may correspond to the decoder part of an auto-encoder, such as the auto-encoder described with FIG. 4A. The decoder 420 receives as input a bitstream b which is entropy decoded (421) and inverse quantized (422). The DNN-based decoder 423 which comprises for instance a set of layers usually composed of (de) convolutional layers, reconstructs the image or group of images Î from the decoded latent.

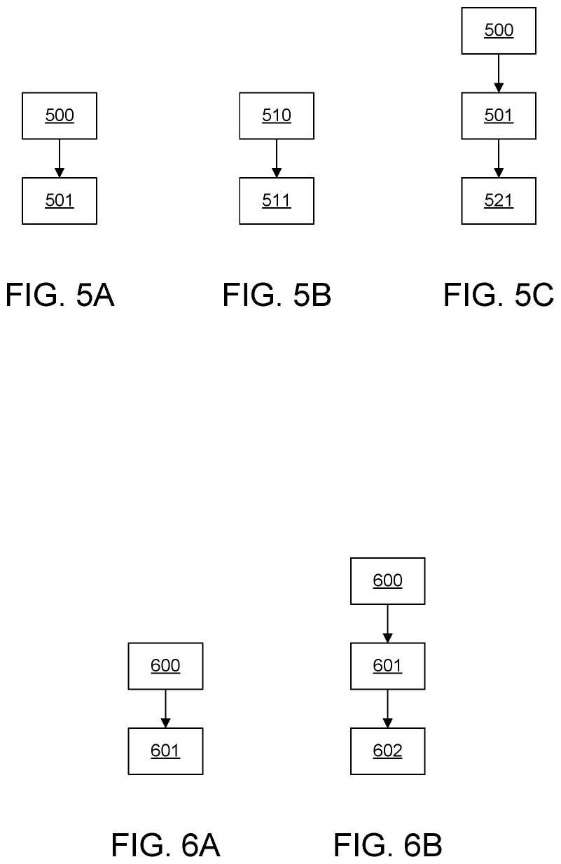

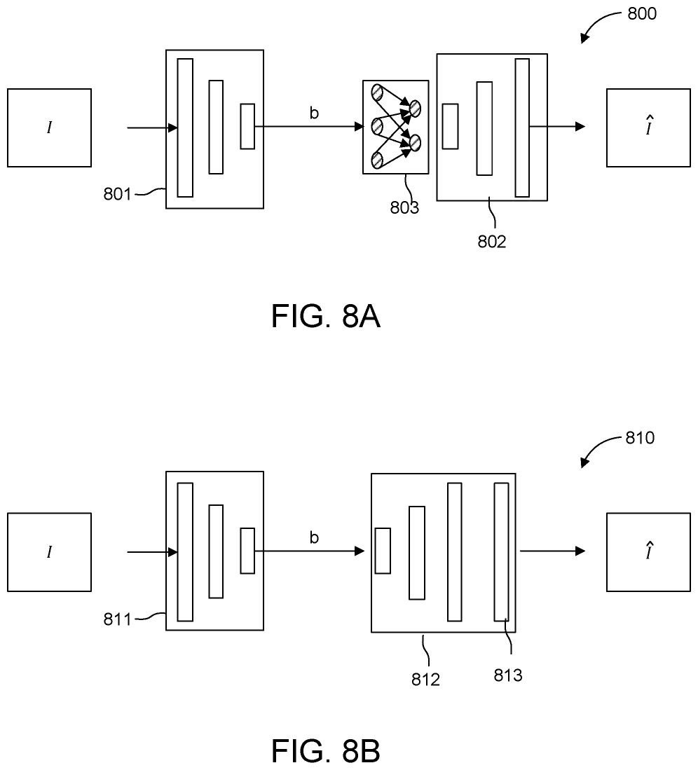

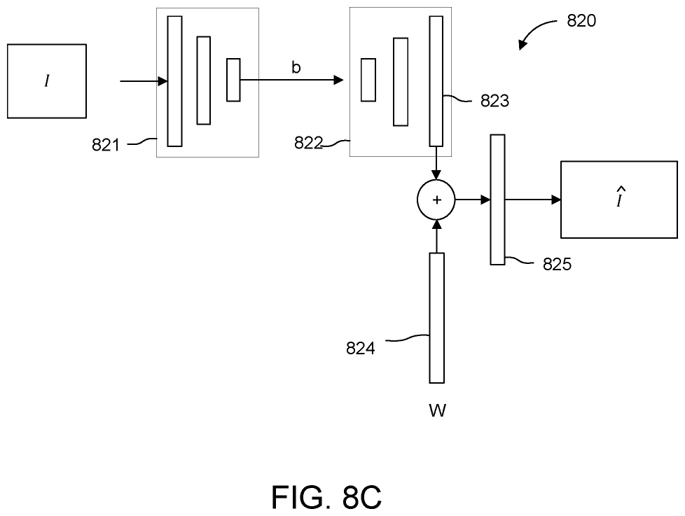

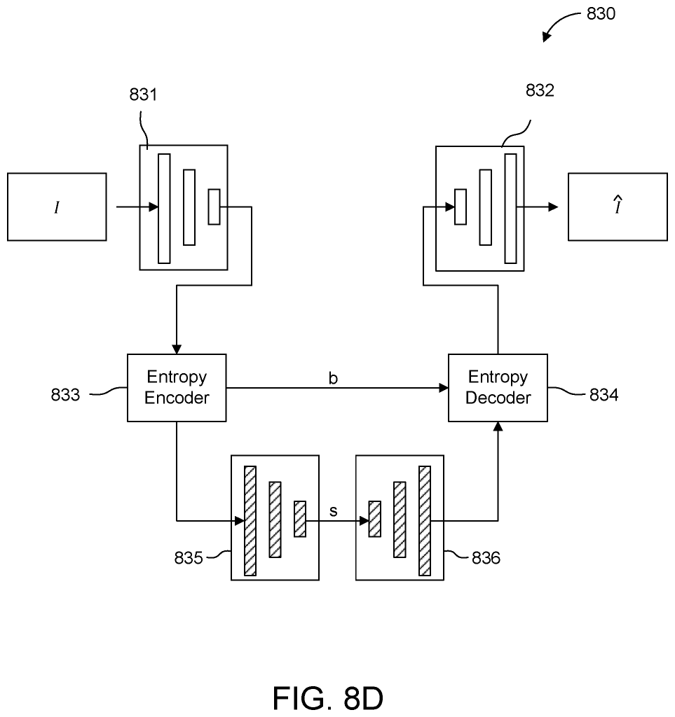

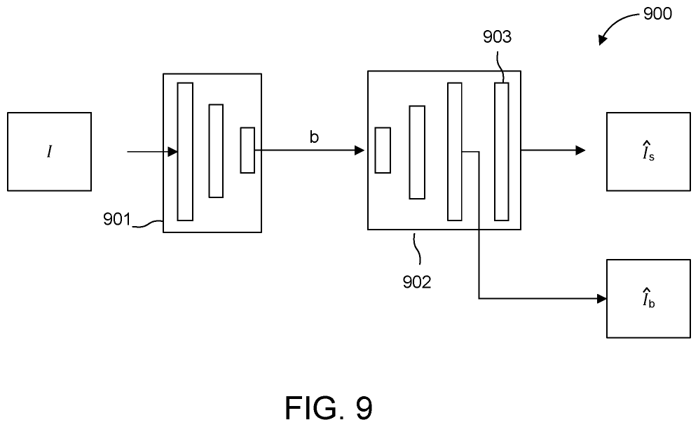

FIG. 5A illustrates a method for obtaining at least one update parameter of a DNN-based decoder, according to an embodiment. The method could be implemented in any one of the encoders described with FIG. 4A or 4B. At least one update parameter is obtained (500) which allows for modifying a DNN decoder defined from a training of a DNN auto-encoder using a first training configuration. The update parameter is obtained as a function of a training of DNN auto-encoder using a second training configuration. The update parameter is then encoded (501). The update parameter could be encoded in a same bitstream as a coded image or in a separate bitstream. The update parameter is representative of a modification of the DNN decoder. Exemplary modifications of the DNN decoder are described in reference to FIGS. 8A-8D and 9.

According to an embodiment, the bitstream is transmitted to a decoder for updating the decoder.

FIG. 5B illustrates an embodiment for obtaining the update parameter of the DNN-based decoder. In this embodiment, the update parameter is obtained in the following manner. The DNN-based auto-encoder is first trained using the first training configuration (510). The learnable parameters of the decoder part of the DNN-based auto-encoder are then stored (511). The DNN-based auto-encoder is re-trained using the second training configuration. In the re-training of the DNN-based auto-encoder, the decoder part of the DNN-based auto-encoder is modified. The update parameter is representative of the modification of the decoder part. Exemplary modifications of the decoder part are described in reference to FIGS. 8A-8D and 9.

FIG. 5C illustrates a method for encoding at least one image or at least a part of an image according to an embodiment. The method could be implemented in any one of the encoders described with FIG. 4A or 4B. At least one update parameter is obtained (500) which allows for modifying a DNN decoder defined from a training of a DNN auto-encoder using a first training configuration. The update parameter is obtained as a function of a training of DNN auto-encoder using a second training configuration. The update parameter is then encoded (501) so that it could be sent to the decoder for updating. The update parameter could be encoded in a same bitstream as a coded image or in a separate bitstream. The update parameter is representative of a modification of the DNN decoder. Exemplary modifications of the DNN decoder are described in reference to FIGS. 8A-8D and 9.

At least one part of an image is encoded (502) in a bitstream, using the DNN auto-encoder which has been trained using the second training configuration. According to an embodiment, the bitstream is transmitted to a decoder.

FIG. 6A illustrates a method for updating a DNN-based decoder, according to an embodiment. The method could be implemented in any one of the decoders described with FIG. 1, 3 or 4C. The decoder receives a bitstream and decodes from the bitstream at least one update parameter (600). The DNN-based decoder is then modified according to the decoded update parameter (601). Exemplary modifications of the DNN decoder are described in reference to FIGS. 8A-8D and 9.

FIG. 6B illustrates a method for decoding at least one part of at least one image, according to an embodiment. The method could be implemented in any one of the decoders described with FIG. 1, 3 or 4C. The decoder receives a bitstream and decodes from the bitstream at least one update parameter (600). The DNN-based decoder is then modified according to the decoded update parameter (601). Exemplary modifications of the DNN decoder are described in reference to FIGS. 8A-8D and 9.

According to an embodiment, another bitstream comprising coded data representative of at least one part of at least one image is received by the decoder. In a variant, the coded data representative of at least one part of at least one image is comprised in the same bitstream as the update parameter. The modified DNN-based decoder then decodes (602) the received data to reconstruct the at least one part of an image.

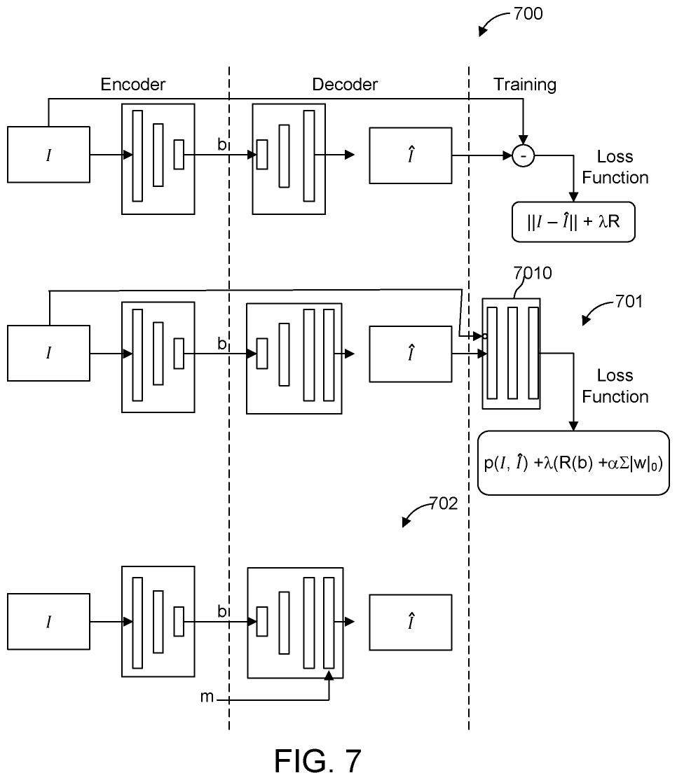

FIG. 7 illustrates an exemplary diagram of an embodiment of a DNN-based encoder and a DNN-based decoder that could implement the methods illustrated in FIGS. 5A, 5B and 6. The encoder may be similar to the encoder described with FIG. 4A or 4B. The decoder may be similar to the decoder described with FIG. 4C.

The auto-encoder (encoder and decoder parts) is trained (700) using an objective metric (typically MSE) and a generic dataset. The loss function also comprises a rate term R which depends on the entropy of the coded latent “b”. A stands for the Lagrangian parameter as it is known in rate-distortion optimization. Once trained in this first configuration, the decoder part of the network is freeze, i.e. the learnable weights of the decoder layers are freeze and stored.

For specific usage, the encoder is then retrained or fine-tuned (701) using another metric for the loss function, typically a “perceptual” metric, or retrain/fine-tune using another domain specific training-set. The “perceptual” metric is represented by the term p(I, Î) on FIG. 7. According to an embodiment, a specific neural network 7010 is used for deriving the loss with the perceptual metric, e.g. a GAN network can be used, or any other suitable neural network.

During the retraining process or fine-tuning, a decoder adaptation is performed. One or more layers are added or removed in the decoder network in addition to the fixed layers already present. According to another variant, an already layer can be adapted. The layer(s) information (update parameter m) is sent to the decoder as part of the bitstream or as side information. The loss function may comprise an additional rate term for taking into account the coding of the update parameter representative of the modification of the decoder. This additional rate term is represented by the term αΣ|w|₀ in FIG. 7.

On the decoder side, the update parameter m is used for updating (702) the DNN-based decoder. Optionally, the default reconstruction of the network can be used for closed loop predictive encoding (typically for video encoding), and the updated reconstruction for display. The default reconstruction of the network may correspond to the reconstructed output from the DNN-based decoder set with the parameters of the first training configuration.

The whole process is described here in the case of an update of the decoder for a second training configuration. However, the embodiments described herein are not limited to one additional training configuration. The DNN-decoder could be trained for one or more additional training configurations resulting in one or more update parameters for the DNN-decoder. Also, in any one of the embodiments described here, only the decoder part could be retrained in the second training configuration or both the encoder part and the decoder part of the auto-encoder can be jointly retrained in the second training configuration.

Below, some exemplary embodiments for modifying a decoder part of an auto-encoder are described. Similar adaptations of the network at the decoder are performed using the adaptation parameter sent to the decoder.

FIG. 8A illustrates a diagram of an exemplary embodiment for modifying a decoder part of an auto-encoder 800 comprising a DNN-based encoder 801 and a DNN-based decoder 802. In grey, the retrained/fine-tuned parts of the auto-encoder are shown. In the decoder part 802, the grey layer 803 at the beginning of the network is added to the original network as shown in FIG. 4A, 4B, or 7. This layer 803 aims at adapting the decoder network 802 to the latent values sent by the encoder 801, which might have a different structure.

FIG. 8B illustrates a diagram of another embodiment for modifying a decoder part of an auto-encoder 810 comprising a DNN-based encoder 811 and a DNN-based decoder 812. In grey, the retrained/fine-tuned parts of the auto-encoder are shown. In the decoder part, the grey layer 813 at the end of the network is added to the original network as shown in FIG. 4A, 4B, or 7. This layer 813 aims at adapting the output of the original decoder layers, to adapt to the modified encoder. In a variant, the additional layer 813 may be placed in between layers of the original network.

FIG. 8C illustrates a diagram of another embodiment for modifying a decoder part of an auto-encoder 820 comprising a DNN-based encoder 821 and a DNN-based decoder 822. In this variant, instead of adding new layer(s), an update on some layers is sent by the encoder. In grey, the retrained/fine-tuned parts of the auto-encoder are shown.

In the example shown in FIG. 8C, the last layer 823 is updated with a layer 824 with weights w resulting in an updated layer 825. The layer update can be performed incrementally, for instance a set of quantized and compressed weights w is added to the original weights of the last layer 823 at the decoder to form the last layer. According to an embodiment, these additional weights are signaled in the coded video bit-stream. In another variant, the layer update is performed by replacing the original layer 823 with the new layer 824.

According to an embodiment, the additional weights w are signaled in the coded video bit-stream or as side information. In a variant, other layers can be updated.

FIG. 8D illustrates a diagram of another embodiment for modifying a decoder part of an auto-encoder 830 comprising a DNN-based encoder 831 and a DNN-based decoder 832. In this variant, the auto-encoder also comprises a hyper encoder 835 configured for learning and coding side information s used by an entropy coder 833 for encoding the latent output by the DNN-based encoder 831 into a bitstream b. The auto-encoder also comprises a hyper decoder 836 configured for decoding the side information s used by an entropy decoder 834 that entropy decodes the bitstream b. More details on hyper-encoder and hyper-decoder can be found in “Joint Autoregressive and hierarchical priors for learned image compression”, D. Minnen, J. Ballé, G. Toderici, NIPS 2018′.

According to the embodiment illustrated in FIG. 8D, the modification of the decoder part of the auto-encoder comprises the updating of the hyper decoder. In grey, the retrained/fine-tuned parts of the auto-encoder are shown. This embodiment allows to update the latent distribution. The modification of the hyper decoder can be made according to any one of the variants described with FIG. 8A, 8B or 8C.

According to another embodiment, the decoder features conditional layers, such as conditional convolutions. Such layers have two inputs: the tensor elements of the output of the previous layers and another tensor which defines the “condition”. The conditional tensor is usually a 2d or 3d tensor, encoded with a one-hot scheme. The tensor shape is 2d if the condition is applied globally, i.e. the condition is the same for all tensor elements or 3D if the condition is applied locally, i.e. the condition is specific for each tensor element.

In this case, the length of the last dimension K of the conditional tensors then depends on the number N of conditions or “modes”, with K=ceil(log 2(N)), ceil being a ceiling function.

In this variant, instead of adding layers or sending additional weights, integer values are signaled alongside the compressed latent to condition the decoding based on the desired output metric optimization. Each integer value is indexed based on the position of their respective conditional layers.

According to another variant, one-hot encoded vectors are sent alongside the compressed latent to condition the decoding. The conditional vectors are compressed and indexed based on the position of their conditional layers in the decoder.

For both variants, not all layers in the decoder need to be conditional.

According to this embodiment, the auto-encoder is jointly trained for all the conditions set for the decoding. For instance, according to the embodiment described with reference to FIG. 7, a joint training is performed for the auto-encoder in the first training configuration and in the second training configuration. In the joint training, both losses are jointly minimized.

The exemplary modifications of the decoder part of the auto-encoder described above in relation with FIG. 8A-D can be performed alone or in combination.

FIG. 9 illustrates a diagram of an exemplary embodiment of an auto-encoder 900 with multiple decoder outputs. The auto-encoder comprising a DNN-based encoder 901 and a DNN-based decoder 902. The example illustrated in FIG. 9 show the modification of the decoder when a layer 903 is added at the end of the decoder. However, this embodiment also applies to the other variants described above for modifying the decoder part of the auto-encoder. In grey, the retrained/fine-tuned parts of the auto-encoder are shown.

According to this variant, the decoder outputs both the original reconstructed frame Î_{b} corresponding to the output of the decoder when trained with a first training configuration, for instance with an objective metric and generic training set, and the frame Îₛ resulting from the training of the adapted layers.

In order to update the decoder, the update parameter is sent to the decoder in the form of one or more syntax elements. According to another variant, the update parameter can also be sent along with the bitstream comprising coded data representative of an image or a video. In this case, in order to decode the “subjective-quality” based reconstructed image or video, the additional syntax elements are sent to the decoder before decoding takes place.

Some variants of the syntax corresponding to the described decoder adaptation are presented in Table 1. The update parameter may comprise one or more of the syntax elements shown below.

TABLE 1

| | |
|---|---|
| decode_layer_update( ) { | |
| layer_update_count | u(8) |
| for(i=0;i< layer_update_count;i++) { | |
| new_layer[i] | u(1) |
| if (not new_layer[i]) | |
| layer_increment[i] | u(1) |
| layer_position[i] | u(8) |
| layer_type[i] | u(4) |
| layer_tensor_dimensions_x[i] | ue( ) |
| layer_tensor_dimensions_y[i] | ue( ) |
| layer_tensor_dimensions_z[i] | ue( ) |
| tensor_data[i] | ue( ) |
| } | |
| } | |

The associated semantic is the following:
layer_update_count: number of layers to be updated,
new_layer: true if the layer is new in the network
layer_increment: if the layer is not new (i.e. this is an update of an existing layer), layer_increment indicates if the update is an increment over existing default weights or if the update comprises the weights directly.
layer_position: the layer position in the network. For a new layer, the position may refers to the position after insertion of the layer. For example, a position of 0 would mean that the first layer is updated.
layer_type: the type of the layer to update. An example of layer type id is as follow:
0: 2D convolutional layer
1: ReLu
2: fully connected layer
3: bias layer
etc.
layer_tensor_dimensions[i]: dimensions of the tensor associated with the layer. Note that not all dimension would be non-null. For example, for a ReLu layer, all dimensions are null since the layer has no parameter.
tensor_data[i]: the layer parameter. According to an embodiment, the layer parameter comprises compressed tensor data.

In a variant, standard methods and syntax to transmit NN models or model updates, such as MPEG7 NNR (compressed Neural Network Representations), can be used to convey the proposed model updates.

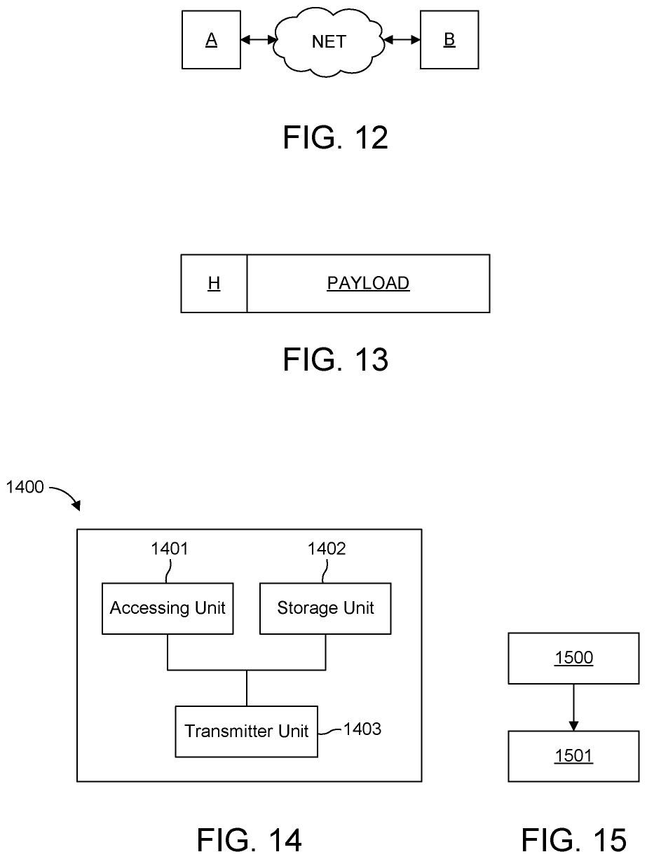

According to an example of the present principles, illustrated in FIG. 12, in a transmission context between two remote devices A and B over a communication network NET, the device A comprises a processor in relation with memory RAM and ROM which are configured to implement a method for obtaining an update parameter or a method for encoding at least one part of at least one image as described in relation with the FIGS. 1-11 and the device B comprises a processor in relation with memory RAM and ROM which are configured to implement a method for updating a DNN-based decoder or for decoding at least one part of at least one image as described in relation with FIGS. 1-11.

In accordance with an example, the network is a broadcast network, adapted to broadcast/transmit encoded update parameters or encoded images from device A to decoding devices including the device B.

A signal, intended to be transmitted by the device A, carries at least one bitstream comprising coded data representative of at least one update parameter for modifying a deep-neural-network-based decoder defined from a training of a deep neural network-based auto-encoder using a first training configuration. The bitstream may comprise syntax elements for the update parameter according to any one of the embodiments described above.

According to an embodiment, this signal may also carry on coded data representative of at one part of at least one image. FIG. 13 shows an example of the syntax of such a signal when the update parameter is transmitted over a packet-based transmission protocol. Each transmitted packet P comprises a header H and a payload PAYLOAD. According to embodiments, the payload PAYLOAD may comprise at least one of the following elements:
an indication of a number of layers to be updated of said deep-neural-network-based decoder,
the at least one update parameter comprises an indication of whether a new layer is to be added to said deep-neural-network-based decoder,
the at least one update parameter comprises an indication of whether a layer of said deep-neural-network-based decoder is updated by an increment of at least one weight of said layer,
the at least one update parameter comprises an indication of whether a layer of said deep-neural-network-based decoder is updated by setting at least one new weight to said layer,
the at least one update parameter comprises an indication of a position in a set of layers of said deep-neural-network based decoder of a layer to update of said deep-neural-network-based decoder,
the at least one update parameter comprises an indication of a position in a set of layers of said deep-neural-network based decoder of a new layer to add,
the at least one update parameter comprises an indication of a layer type of a layer to update or of a new layer,
the at least one update parameter comprises an indication of a tensor dimension of a layer to update or of a new layer,
the at least one update parameter comprises at least one layer parameter of a layer to update or of a new layer.

According to an embodiment, the payload comprises coded data representative of at least one part of at least one image encoded according to any one of the embodiments described above.

FIG. 14 illustrates an embodiment of an apparatus 1400 for transmitting such a signal. The apparatus comprises an accessing unit 1401 configured to access data stored on a storage unit 1402. The data comprises a signal according to any one of the embodiments described above. The apparatus also comprises a transmitter 1403 configured to transmit the accessed data. According to an embodiment, the apparatus 1400 is comprised in the device illustrated in FIG. 1.

FIG. 15 illustrates an embodiment of a method for transmitting a signal according to any one of the embodiments described above. Such a method comprises accessing data (1500) comprising such a signal and transmitting the accessed data (1501). According to an embodiment, the method can be performed by the device illustrated on any one of the FIG. 1 or 14.

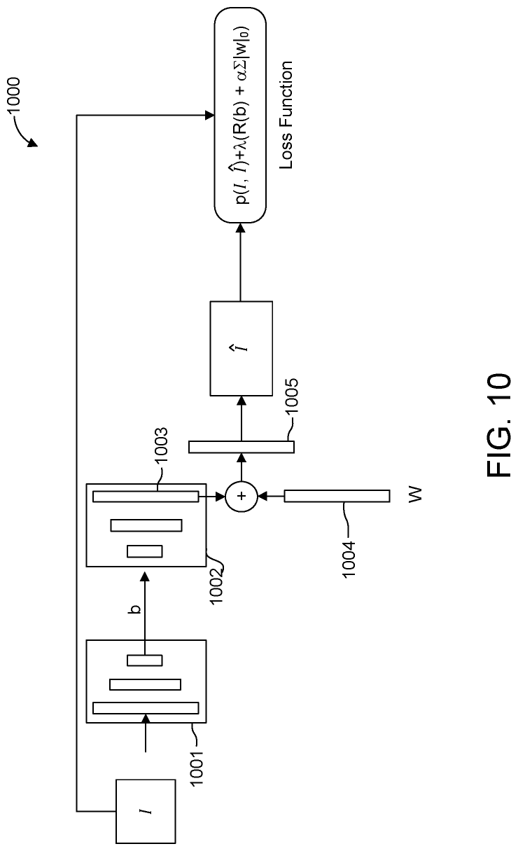

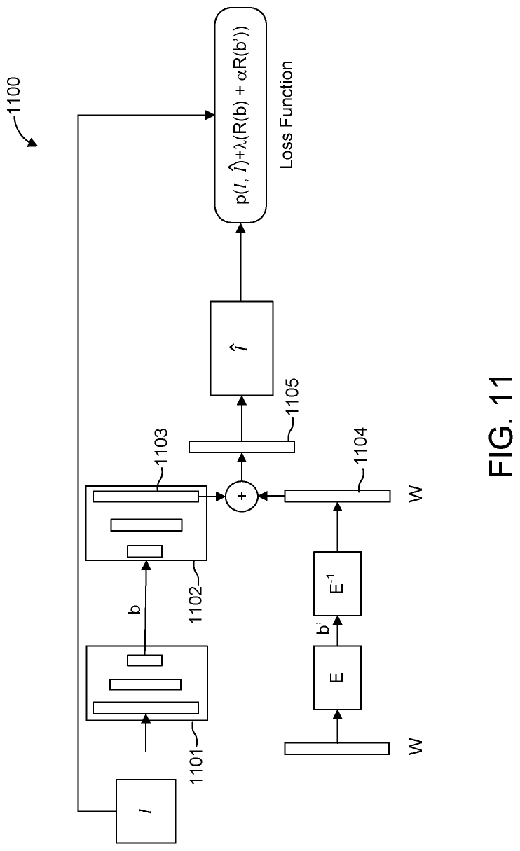

FIGS. 10 and 11 detail exemplary loss functions that can be used for training or fine-tuning the networks described with the above embodiments. Typically, the metric used is not the MSE anymore, and could be a perceptual metric or the training set could be specific to a domain/application.

FIG. 10 illustrates a diagram of an exemplary embodiment of an auto-encoder 1000 comprising a DNN-based encoder 1001 and a DNN-based decoder 1002 wherein the last layer 1003 is updated with a layer 1004 with weights w resulting in an updated layer 1005. In grey, the retrained/fine-tuned parts of the auto-encoder are shown. The training adaptation is shown in FIG. 10 for the layer update case, but the same principle can be applied to other variants of decoder modifications.

At training, the loss is adapted as follows: a regularization term is added to the loss to guarantee the added weights w sparsity. Here the parsimony is expressed using a L0 norm. A L1 norm can also be used. The parameter a allows to normalize the additional rate brought by the network update: for example, for a given image size to encode, the normalization factor takes into account the fact that the network update is sent only once for the whole image. For video, the network update is sent for example once every N images.

FIG. 11 illustrates a diagram of an exemplary embodiment of an auto-encoder 1100 comprising a DNN-based encoder 1101 and a DNN-based decoder 1102 wherein the last layer 1103 is updated with a layer 1104 with weights w resulting in an updated layer 1105. In grey, the retrained/fine-tuned parts of the auto-encoder are shown. The training adaptation is shown in FIG. 11 for the layer update case, but the same principle can be applied to other variants of decoder modifications.

In this variant, instead of a weight sparsity, an entropy measure is used instead of a L0 norm. The entropy measure is more exactly a proxy of entropy as the one used in entropy bottleneck of compressive auto-encoder as in “Joint Autoregressive and hierarchical priors for learned image compression”, D. Minnen, J. Ballé, G. Toderici, NIPS 2018”. It guarantees that the weights update has a reasonable bitrate overhead. The loss is changed as: p(I, Î)+λ(R(b)+αH(w)), where H(x) is the estimated entropy of x.

During the training, both the encoder 1101 and the weights update w are changed. In this variant, the weights are increments from the default weights of the last layer. But, the weights could also be a new set of weights. In the loss function, the rate of the latent b for a set of samples and the rate of weights update b′ are used.

The weights update coding uses a fix, given entropy coder E and decoder E⁻¹. These coder and decoder are fixed and known at the DNN-based decoder. As in the classical decoder, the weights are quantized. Other given coder/decoder can also be used to encode the update parameters, for example a given auto-encoder as in “Joint Autoregressive and hierarchical priors for learned image compression”, D. Minnen, J. Ballé, G. Toderici, NIPS 2018”, trained with a set of weights update. The weights update training set are for example given by domain adaptation or metric adaptation.

In order to fix the α coefficient, giving the balance between the rate of the latent and the rate of the weights update, several strategies are available depending on the application:

If only 1 image is to be sent, then α=1 because the weights update will be used only once together with the latent.

If many images are to be sent for a specific application, then α is decreased. If the number of images N to send is known, then α can be fixed to 1/N.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, of a video encoder 200 and decoder 300 as shown in FIG. 2 and FIG. 3 or an image or video auto-encoder 400, an image or video DNN-based encoder 410 or an image or video DNN-based decoder 420 as shown in FIGS. 4A, 4B and 4C. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of embodiments have been described. Features of these embodiments can be provided alone or in any combination, across various claim categories and types. Further, embodiments can include one or more of the following features, devices, or aspects, alone or in any combination, across various claim categories and types:
encoding/decoding at least one part of at least one image using at least said modified decoder,
adding at least one new layer to the deep neural network-based decoder, at the beginning of a set of layers of said deep neural network-based decoder, or at the end of a set of layers of said deep neural network-based decoder, or between two layers of a set of layers of said deep neural network-based decoder,
updating at least one layer of a set of layers of the deep neural network-based decoder,
updating said hyper decoder, when the deep neural network-based decoder comprises a hyper decoder configured for decoding side information used by an entropy decoder configured for entropy decoding a bitstream,
the update parameter is representative of a condition for driving at least one conditional of the deep neural network-based decoder,
the deep-neural-network-based decoder is configured for outputting first reconstructed data obtained with said deep-neural-network-based decoder without modification of said deep-neural-network-based decoder, said first reconstructed data being used for reference by said deep-neural-network-based decoder,
the deep-neural-network-based decoder is configured for outputting second reconstructed data obtained with said modified decoder, said second reconstructed data being used for display,
the at least one update parameter is obtained by:
   Training said deep neural network-based auto-encoder using said first training configuration,
   Storing learnable parameters of a decoder of said deep neural network-based auto-encoder,
   Retraining said deep neural network-based auto-encoder using said second training configuration, wherein retraining said deep neural network-based auto-encoder comprises modifying a decoder of said deep neural network-based auto-encoder, said at least one update parameter being representative of said modification,
the at least one update parameter is obtained by a joint training of said deep neural network-based auto-encoder comprising a training of said deep neural network-based auto-encoder using said first training configuration, and a training said deep neural network-based auto-encoder using said second training configuration,
the first training configuration comprises a loss function based on an objective measure and/or a generic dataset,
the second training configuration comprises a loss function based on a subjective quality measure,
the second training configuration comprises a dataset with specific video content type,
the training of said deep neural network-based auto-encoder using said second training configuration is based on a loss function comprising a regularization term to guarantee sparsity of the parameters of the updated layer or added layer to the decoder part,
the training of said deep neural network-based auto-encoder using said second training configuration is based on a loss function comprising a bitrate cost of the at least one update parameter encoding,
the regularization term or said bitrate cost is weighted to take into account a number of images for which the at least one update parameter is sent,
the at least one update parameter comprises at least one additional syntax element received by said deep-neural-network-based decoder,
the at least one update parameter comprises an indication of a number of layers to be updated of said deep-neural-network-based decoder,
the at least one update parameter comprises an indication of whether a new layer is to be added to said deep-neural-network-based decoder,
the at least one update parameter comprises an indication of whether a layer of said deep-neural-network-based decoder is updated by an increment of at least one weight of said layer,
the at least one update parameter comprises an indication of whether a layer of said deep-neural-network-based decoder is updated by setting at least one new weight to said layer,
the at least one update parameter comprises an indication of a position in a set of layers of said deep-neural-network based decoder of a layer to update of said deep-neural-network-based decoder,
the at least one update parameter comprises an indication of a position in a set of layers of said deep-neural-network based decoder of a new layer to add,
the at least one update parameter comprises an indication of a layer type of a layer to update or of a new layer,
the at least one update parameter comprises an indication of a tensor dimension of a layer to update or of a new layer,
the at least one update parameter comprises at least one layer parameter of a layer to update or of a new layer.

1. A method, comprising:
obtaining a latent representative of at least one part of at least one image;
decoding at least one update parameter representative of a modification to apply to a deep neural network-based decoder;
modifying the deep neural network-based decoder based on the decoded update parameter, and
reconstructing the at least one part of at least one image from the latent using at least said modified deep neural network-based decoder.

2. (canceled)

3. (canceled)

4. A method, comprising:
obtaining at least one update parameter for modifying a deep-neural-network-based decoder defined from a training of a deep neural network-based auto-encoder using a first training configuration, said at least one update parameter being obtained as a function of a training of said deep neural network-based auto-encoder using a second training configuration,
encoding at least one part of at least one image using at least the neural network-based auto-encoder trained using the second training configuration; and
encoding said at least one update parameter.

5. (canceled)

6. (canceled)

7. An apparatus, comprising one or more processors, wherein said one or more processors are configured to:
obtain a latent representative of at least one part of at least one image;
decode at least one update parameter representative of a modification to apply to a deep neural network-based decoder;
modify a deep neural network-based decoder based on the decoded update parameter; and
reconstruct the at least one part of at least one image from the latent using at least said modified deep neural network-based decoder.

8. (canceled)

9. An apparatus, comprising one or more processors, wherein said one or more processors are configured to:
obtain at least one update parameter for modifying a deep-neural-network-based decoder defined from a training of a deep neural network-based auto-encoder using a first training configuration, said at least one update parameter being obtained as a function of a training of said deep neural network-based auto-encoder using a second training configuration;
encode at least one part of at least one image using at least the neural network-based auto-encoder trained using the second training configuration; and
encode said at least one update parameter.

10. (canceled)

11. The method of claim 1, wherein modifying said deep neural network-based decoder comprises at least one of adding at least one new layer to said deep neural network-based decoder and updating at least one layer of a set of layers of said deep neural network-based decoder.

12. (canceled)

13. The method of claim 4, wherein modifying said deep neural network-based decoder comprises at least one of adding at least one new layer to said deep neural network-based decoder and updating at least one layer of a set of layers of said deep neural network-based decoder.

14. The method of claim 1, wherein said deep neural network-based decoder comprises a hyper decoder configured for decoding side information used by an entropy decoder configured for entropy decoding said bitstream, and wherein modifying said deep neural network-based decoder comprises updating said hyper decoder.

15. (canceled)

16. The method of claim 1, wherein said deep-neural-network-based decoder is configured for outputting first reconstructed data obtained with said deep-neural-network-based decoder, said first reconstructed data being used for reference by said deep-neural-network-based decoder, and wherein said deep-neural-network-based decoder is configured for outputting second reconstructed data obtained with said modified decoder, said second reconstructed data being used for display.

17. The method of claim 4, wherein obtaining said at least one update parameter comprises:
training said deep neural network-based auto-encoder using said first training configuration;
storing learnable parameters of a decoder of said deep neural network-based auto-encoder; and
retraining said deep-neural-network-based decoder using said second training configuration, wherein said retraining comprises modifying said deep neural network-based decoder, said at least one update parameter being representative of said modification.

18. The method of claim 17, wherein said retraining comprises jointly retraining an encoder part of said deep-neural-network-based auto-encoder using said second training configuration.

19. (canceled)

20. (canceled)

21. The method of claim 4, wherein said second training configuration comprises a loss function based on at least one of a subjective quality metric and a metric defined for a machine task or wherein said second training configuration comprises a dataset with specific video content type.

22.-27. (canceled)

28. The method of claim 1, wherein said at least one update parameter comprises at least one of:
an indication of a number of layers to be updated of said deep-neural-network-based decoder;
an indication of whether a new layer is to be added to said deep-neural-network-based decoder;
an indication of whether a layer of said deep-neural-network-based decoder is updated by an increment of at least one weight of said layer;
an indication of whether a layer of said deep-neural-network-based decoder is updated by setting at least one new weight to said layer;
an indication of a position in a set of layers of said deep-neural-network based decoder of a layer to update of said deep-neural-network-based decoder;
an indication of a position in a set of layers of said deep-neural-network based decoder of a new layer to add;
an indication of a layer type of a layer to update or of a new layer;
an indication of a tensor dimension of a layer to update or of a new layer; and
at least one layer parameter of a layer to update or of a new layer.

29.-37. (canceled)

38. A computer readable medium comprising a bitstream comprising data representation of a latent representative of at least one part of at least one image and data representative of at least one update parameter representative of a modification to apply to a deep-neural-network-based decoder for reconstructing said at least one part of at least one image.

39. A computer readable storage medium having stored thereon instructions for causing one or more processors to perform the method of claim 1.

40. A computer readable storage medium having stored thereon instructions for causing one or more processors to carry out the method of claim 4.

41. The computer readable medium of claim 38, wherein said at least one update parameter comprises at least one of:
an indication of a number of layers to be updated of said deep-neural-network-based decoder;
an indication of whether a new layer is to be added to said deep-neural-network-based decoder;
an indication of whether a layer of said deep-neural-network-based decoder is updated by an increment of at least one weight of said layer;
an indication of whether a layer of said deep-neural-network-based decoder is updated by setting at least one new weight to said layer;
an indication of a position in a set of layers of said deep-neural-network based decoder of a layer to update of said deep-neural-network-based decoder;
an indication of a position in a set of layers of said deep-neural-network based decoder of a new layer to add;
an indication of a layer type of a layer to update or of a new layer;
an indication of a tensor dimension of a layer to update or of a new layer; and
at least one layer parameter of a layer to update or of a new layer.

42. The method of claim 4, wherein said at least one update parameter comprises at least one of:
an indication of a number of layers to be updated of said deep-neural-network-based decoder;
an indication of whether a new layer is to be added to said deep-neural-network-based decoder;
an indication of whether a layer of said deep-neural-network-based decoder is updated by an increment of at least one weight of said layer;
an indication of whether a layer of said deep-neural-network-based decoder is updated by setting at least one new weight to said layer;
an indication of a position in a set of layers of said deep-neural-network based decoder of a layer to update of said deep-neural-network-based decoder;
an indication of a position in a set of layers of said deep-neural-network based decoder of a new layer to add;
an indication of a layer type of a layer to update or of a new layer;
an indication of a tensor dimension of a layer to update or of a new layer; and
at least one layer parameter of a layer to update or of a new layer.

43. The apparatus of claim 7, wherein said at least one update parameter comprises at least one of:
an indication of a number of layers to be updated of said deep-neural-network-based decoder;
an indication of whether a new layer is to be added to said deep-neural-network-based decoder;
an indication of whether a layer of said deep-neural-network-based decoder is updated by an increment of at least one weight of said layer;
an indication of whether a layer of said deep-neural-network-based decoder is updated by setting at least one new weight to said layer;
an indication of a position in a set of layers of said deep-neural-network based decoder of a layer to update of said deep-neural-network-based decoder;
an indication of a position in a set of layers of said deep-neural-network based decoder of a new layer to add;
an indication of a layer type of a layer to update or of a new layer;
an indication of a tensor dimension of a layer to update or of a new layer; and
at least one layer parameter of a layer to update or of a new layer.

44. The apparatus of claim 9, wherein said at least one update parameter comprises at least one of:
an indication of a number of layers to be updated of said deep-neural-network-based decoder;
an indication of whether a new layer is to be added to said deep-neural-network-based decoder;
an indication of whether a layer of said deep-neural-network-based decoder is updated by an increment of at least one weight of said layer;
an indication of whether a layer of said deep-neural-network-based decoder is updated by setting at least one new weight to said layer;
an indication of a position in a set of layers of said deep-neural-network based decoder of a layer to update of said deep-neural-network-based decoder;
an indication of a position in a set of layers of said deep-neural-network based decoder of a new layer to add;
an indication of a layer type of a layer to update or of a new layer;
an indication of a tensor dimension of a layer to update or of a new layer; and
at least one layer parameter of a layer to update or of a new layer.

45. The computer readable storage medium of claim 39, wherein said at least one update parameter comprises at least one of:
an indication of a number of layers to be updated of said deep-neural-network-based decoder;
an indication of whether a new layer is to be added to said deep-neural-network-based decoder;
an indication of whether a layer of said deep-neural-network-based decoder is updated by an increment of at least one weight of said layer;
an indication of whether a layer of said deep-neural-network-based decoder is updated by setting at least one new weight to said layer;
an indication of a position in a set of layers of said deep-neural-network based decoder of a layer to update of said deep-neural-network-based decoder;
an indication of a position in a set of layers of said deep-neural-network based decoder of a new layer to add;
an indication of a layer type of a layer to update or of a new layer;
an indication of a tensor dimension of a layer to update or of a new layer; and
at least one layer parameter of a layer to update or of a new layer.
